(19) United States
(12) Patent Application Publication
(10) Pub. No.: US 2026/0235514 A1
(43) Pub. Date: Aug. 13, 2026

(54) LIGHT-GUIDING MEMBER AND GAS SENSOR

(71) Applicant: Asahi Kasei Microdevices Corporation, Tokyo (JP)

(72) Inventors: Hiroki UMEDA, Tokyo (JP); Yuji GODA, Tokyo (JP)

(73) Assignee: Asahi Kasei Microdevices Corporation, Tokyo (JP)

(21) Appl. No.: 19/456,230

(22) Filed: Jan. 22, 2026

(30) Foreign Application Priority Data
Feb. 7, 2025 (JP) 2025-019616
Nov. 28, 2025 (JP) 2025-209717

(51) Int. Cl. G01N 21/61; G01N 21/01

(52) U.S. Cl. CPC G01N 21/61; G01N 21/01; G01N 2021/0112; G01N 2201/022; G01N 2201/0636

(57) ABSTRACT

A light-guiding member 5 for a gas sensor is attached to a main surface side of a substrate, the light-guiding member 5 has a first surface 5ts that is attached to a main surface in the light-guiding member to form a cavity into which a gas is introduced between the main surface of the substrate and the first surface 5ts, and that has a ventilation opening 7 formed therein and communicating with the cavity. The ventilation opening 7 includes at least one beam 8 extending between edges 7es, 7el of the ventilation opening 7. The at least one beam 8 has a length in a plane-normal direction perpendicular to the first surface 5ts that is longer than a minimum length L8s of the at least one beam 8 in an in-plane direction of the first surface 5ts.

### CROSS-REFERENCE TO RELATED APPLICATION

The present application claims priority to and the benefit of Japanese Patent Application No. 2025-019616 filed February 7, 2025, and Japanese Patent Application No. 2025-209717 filed November 28, 2025, the entire contents of which are incorporated herein by reference.

### TECHNICAL FIELD

The present disclosure relates to light-guiding members and gas sensors.

### BACKGROUND

Conventionally, as light-guiding members for gas sensors, light-guiding members that are attached to a main surface side of a substrate having a light emitter that emits light and a light receiver that receives light on the main surface side, and that guide light emitted by the light emitter to the light receiver, and gas sensors that include such light-guiding members, are known. For example, in Patent Literature (PTL) 1, a gas cell housing for a gas sensor (light-guiding member), which includes a mirror portion having a plurality of reflectors, all of which are integrally molded on the inner surface of a housing portion, and a gas sensor including the gas cell housing for a gas sensor (light-guiding member) are described. The light-guiding member and the gas sensor described in PTL 1 are said to eliminate the need for a process for incorporating a mirror portion into a gas cell housing (light-guiding member), thereby simplifying an adjustment process of adjusting assembly tolerances of sensitive optical components.

### CITATION LIST

### Patent Literature

PTL 1: JP 2022-029422 A

### SUMMARY

### Technical Problem

As in the device described in PTL 1, gas sensors typically require an opening (ventilation opening) in the light-guiding member or the like for introducing and discharging a gas to be measured. Therefore, strength of the light-guiding member is decreased by the amount that is a through hole serving as a ventilation opening, and the light-guiding member becomes more susceptible to deformation. When the light-guiding member is deformed, the function as a gas sensor may be lost, or a reflector or the like may need to be recalibrated. This tendency can be particularly pronounced when the reflector is integrally molded with the light-guiding member, as in the device described in PTL 1. On the other hand, when the opening area of a ventilation opening is not sufficient, the function as a ventilation opening is impaired.

Accordingly, it would be helpful to provide a light-guiding member and a gas sensor that have a ventilation opening that secures a sufficient opening area, while being less prone to lose strength.

### Solution to Problem

Means for achieving the above are as follows:

(1) The light-guiding member of the present disclosure is

a light-guiding member for a gas sensor, attached to a main surface side of a substrate having a light emitter and a light receiver on the main surface side, the light emitter configured to emit light and the light receiver configured to receive at least a portion of the light emitted by the light emitter, the light-guiding member being configured to guide at least a portion of the light emitted by the light emitter to the light receiver, wherein

the light-guiding member comprises a first surface that is attached to a main surface in the light-guiding member to form a cavity into which a gas is introduced between the main surface of the substrate and the first surface, and that has a ventilation opening formed therein and communicating with the cavity,

the ventilation opening includes at least one beam extending between edges of the ventilation opening, and

the at least one beam has a length in a plane-normal direction perpendicular to the first surface that is longer than a minimum length of the at least one beam in an in-plane direction of the first surface.

(2) The light-guiding member according to (1), wherein

a maximum length of the at least one beam in the in-plane direction is three times or more the minimum length of the at least one beam in the in-plane direction.

(3) The light-guiding member according to (1) or (2), wherein

the first surface is a top surface of the light-guiding member.

(4) The light-guiding member according to any one of (1) to (3), wherein,

in a hypothetical configuration in which the ventilation opening does not include the at least one beam, the ventilation opening has a rectangular shape in plan view, and

the at least one beam includes a first beam extending in the short direction of the ventilation opening in the in-plane direction.

(5) The light-guiding member according to (4), wherein

the first beam has an upper surface parallel to the first surface and a side surface adjacent to the upper surface and extending in the plane-normal direction, and

the side surface of the first beam extends at an angle relative to the plane-normal direction so that, in a cross-section view perpendicular to an extension direction of the first beam in plain view, the length of the first beam in the in-plane direction becomes shorter or longer approaching the upper surface.

(6) The light-guiding member according to (5), wherein,

in a cross-section view perpendicular to the extension direction of the first beam in plain view, an inclination angle of the side surface of the first beam with respect to the plane-normal direction is 0.5° to 10°.

(7) The light-guiding member according to any one of (1) to (6), wherein

the ventilation opening includes a plurality of beams that includes the at least one beam, and at least two of the beams intersect with each other in plain view.

(8) The light-guiding member according to any one of (1) to (7), wherein

the first surface has a recess formed in a region including the ventilation opening and a periphery thereof in plain view.

(9) A gas sensor of the present disclosure comprises

the light-guiding member according to any one of (1) to (8) and the substrate.

### Advantageous Effect

According to the present disclosure, it is possible to provide a light-guiding member and a gas sensor that have a ventilation opening that secures a sufficient opening area, while being less prone to lose strength.

### BRIEF DESCRIPTION OF THE DRAWINGS

In the accompanying drawings:

FIG. 1 is a perspective view diagram of a gas sensor according to an embodiment of the present disclosure, viewed from above in a front right side view;

FIG. 2 is a perspective view diagram of a light-guiding member according to a first embodiment of the present disclosure, which is included in the gas sensor of FIG. 1, viewed from above in a front right side view;

FIG. 3 is a perspective view diagram of the light-guiding member of FIG. 2, viewed from below in a rear left side view;

FIG. 4 is a schematic perspective view diagram of the gas sensor of FIG. 1, with a portion of the gas sensor being transparent, for explaining an optical path in the gas sensor;

FIG. 5 is a plan view diagram of a top surface of the light-guiding member of FIG. 2 for explaining a configuration of a ventilation opening and beams;

FIG. 6A is a perspective view diagram of one beam for explaining a configuration of the beam;

FIG. 6B is a cross-section diagram of a cross-section taken along A-A of FIG. 6A;

FIG. 6C is a cross-section diagram similar to FIG. 6B, illustrating another example of the cross-section taken along A-A of FIG. 6A;

FIG. 6D is a cross-section diagram similar to FIG. 6B, illustrating another example of the cross-section taken along A-A of FIG. 6A; and

FIG. 7 is a perspective view diagram of the light-guiding member according to a second embodiment of the present disclosure, viewed as in FIG. 2.

### DETAILED DESCRIPTION

A light-guiding member and a gas sensor according to an embodiment of the present disclosure are described with reference to the accompanying drawings.

Members and sites common to each drawing are marked with the same reference signs. The drawings are schematic, and dimensions and proportions of each member and portion, and dimensional relationships or proportions between the drawings, may not be to scale.

### Gas sensor

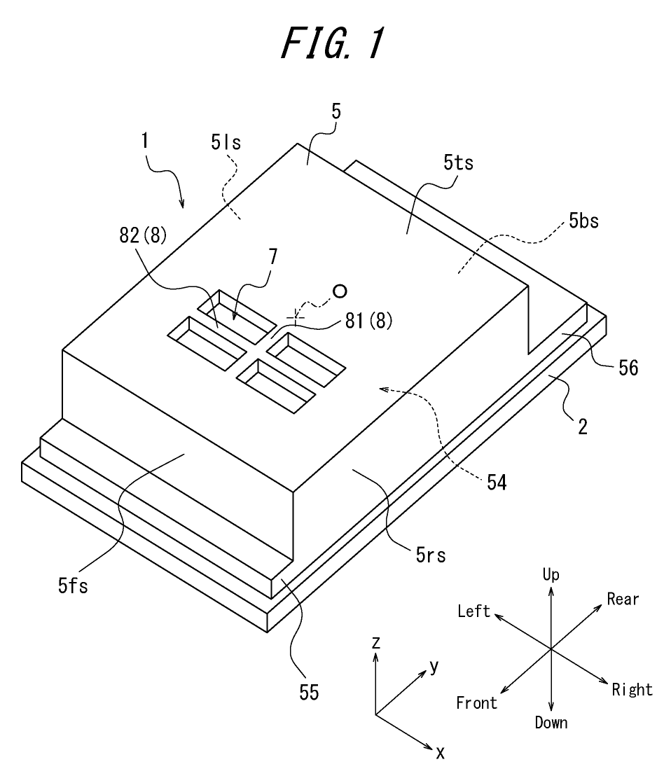

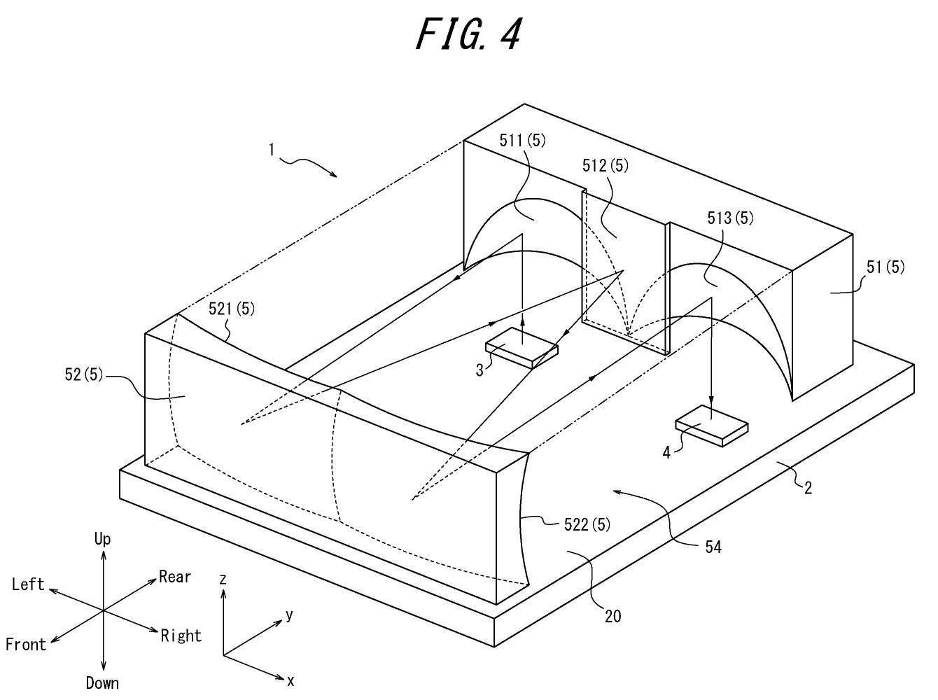

First, a basic configuration of the gas sensor according to an embodiment of the present disclosure is described, with reference to FIG. 1 and FIG. 4.

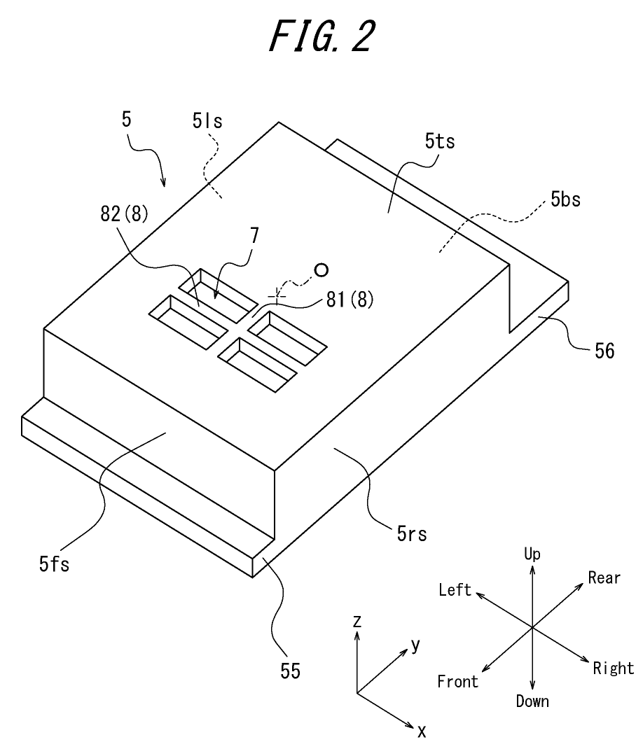

FIG. 1 is a perspective view diagram of the gas sensor according to a first embodiment of the present disclosure, viewed from above in a front right side view. FIG. 4 is a schematic perspective view diagram of the gas sensor of FIG. 1, with a portion of the gas sensor being transparent, for explaining an optical path in the gas sensor. However, for the sake of simplicity, the gas sensor 1 is illustrated in FIG. 1 without illustrating the inside of the light-guiding member 5, such as a light emitter 3 and a light receiver 4 illustrated in FIG. 4, which could be seen through a ventilation opening 7. Further, similarly, in FIG. 4, a front foot portion 55 and a rear foot portion 56 (see FIG. 1 and FIG. 2) of the light-guiding member 5, which are described later, are omitted from the illustration.

According to the present embodiment, the gas sensor 1 is a small device having dimensions of, for example, 30µm ´ 20µm ´ 10µm. According to the present embodiment, the gas sensor 1 is a non-dispersive infrared (NDIR) gas detection device that measures concentration of a gas to be detected based on infrared rays transmitted through an introduced gas body. As another example, the gas sensor 1 may be a photoacoustic gas detection device. The gas to be detected may be, for example, carbon dioxide, water vapor, methane, ethane, propane, butane, formaldehyde, carbon monoxide, nitrogen monoxide, ammonia, sulfur dioxide, alcohol (methanol, ethanol, or the like), a chlorofluorocarbon, a hydrochlorofluorocarbon, a hydrofluorocarbon, a refrigerant gas (R32, R290, or the like), or a mixture of these.

The configuration of the gas sensor 1 according to the present embodiment allows use as a light emitting and receiving device for applications other than gas detection. That is, disclosure obtained by replacing the term "gas sensor" described in the specification and claims of this application with "optical concentration measuring device", "optical physical quantity measuring device", "light receiving and emitting device", "optical device", or the like, is included in the scope of the present disclosure. For example, the state of an optical path space can be detected (examples other than gas include the presence or absence or concentration of a specific component of a fluid). For example, the disclosure content can be used for a component detection device or a component concentration measuring device for a substance (for example, water or a body fluid) present in an optical path space between the light emitter and the light receiver. For example, when the substance present in the optical path space is blood, the component detection device or the component concentration measuring device can be used to measure glucose concentration in blood.

The component detection device or the component concentration measuring device can measure glucose concentration in blood by measuring absorption of light having a wavelength of 1µm to 10µm. In the measurement of glucose concentration in blood, measuring absorption of light at 1.6µm, 2.0µm to 2.3µm, and 9.6µm is preferred. A compact, high precision, and highly reliable non-invasive glucose concentration meter can be realized. Such a glucose concentration meter allows, for example, a diabetic patient to self-check blood sugar levels with good precision and without causing damage to the skin as would occur with an invasive method. Further, more accurate administration of medication (for example, insulin) can be achieved, based on the blood sugar levels checked.

As illustrated in FIG. 1 and FIG. 4, the gas sensor 1 includes a substrate 2, the light emitter 3, the light receiver 4, and the light-guiding member 5. FIG. 4 illustrates an example configuration of the gas sensor 1 with a portion of the light-guiding member 5 being transparent, where the light emitter 3 and the light receiver 4 on a main surface 20 of the substrate 2 are visible. According to the present embodiment, the main surface 20 is a surface among those having the largest area of the substrate 2 on which the light-guiding member 5 is disposed. The light-guiding member 5 of the present embodiment is the light-guiding member 5 of some embodiments described in detail later.

Hereinafter, as illustrated in each of FIG. 1 to FIG. 7, for convenience of explanation, Cartesian coordinates are set so that the xy plane is parallel to the main surface 20 of the substrate 2. The z-axis direction is perpendicular to the main surface 20 of the substrate 2. The x-axis direction and the y-axis direction are parallel to sides of the main surface 20 of the substrate 2. Here, the y-axis direction corresponds to the direction in which a first reflector 51 and a second reflector 52 described later face each other, and the direction from the second reflector 52 to the first reflector 51 is defined as the positive y-axis direction.

Further, hereinafter, unless otherwise specified, in the Cartesian coordinates indicated in each drawing, the y-axis direction is sometimes referred to as the front-rear direction, the negative y-axis direction (negative side) as the front (front direction, front side), and the positive y-axis direction (positive side) as the rear (rear direction, rear side, back side). Further, the x-axis direction is sometimes referred to as the left-right direction, the negative x-axis direction (negative side) as the left (left direction, left side), and the positive x-axis direction (positive side) as the right (right direction, right side). Further, the z-axis direction is sometimes referred to as the up-down direction, the positive z-axis direction (positive side) as the top (upward direction, upper side), and the negative z-axis direction (negative side) as the bottom (downward direction, lower side).

The substrate 2 is a plate-like member on which components of the gas sensor 1 are mounted and on which mounted electronic components are electrically connected. The substrate 2 may be, for example, a printed circuit board in which conductive wiring is printed on a plate made of glass epoxy resin, a flexible printed circuit board, or the like. Further, the substrate 2 may be, for example, a ceramic substrate. The substrate 2 has the light emitter 3 including a light-emitting element and the light receiver 4 including a light-receiving element provided on the main surface 20 thereof. That is, the substrate 2 has on the main surface 20 side, the light emitter 3 that emits light and the light receiver 4 that receives at least a portion of the light emitted by the light emitter 3. The substrate 2 may further have other electronic components mounted thereon. For example, the substrate 2 may be provided with a controller that controls at least one of the light emitter 3 or the light receiver 4 on the main surface 20 or on a bottom surface that is the opposite side to the main surface 20. The controller may include an analog front-end (AFE) or an analog-to-digital converter (ADC). Further, the substrate 2 may be provided with an arithmetic unit on the main surface 20 or on the bottom surface to execute arithmetic operations in gas concentration calculation. The arithmetic unit may include at least one general-purpose processor that executes functions according to a program to be read and may include at least one dedicated processor specialized for a particular process. The dedicated processor may include an application specific integrated circuit (ASIC). The processor may include a programmable logic device (PLD) or a microcontroller unit (MCU). The arithmetic unit may be integrated with the controller described above.

The light emitter 3 (more specifically, the light-emitting element that constitutes the light emitter 3) is a component that emits light used to detect gas to be detected. The light emitter 3 is not particularly limited as long as the light emitter 3 outputs light including a wavelength that is absorbed by the gas to be detected. According to the present embodiment, the light emitted by the light emitter 3 is infrared light but is not limited to this example. According to the present embodiment, the light emitter 3 is a light-emitting diode (LED), but other examples may include a semiconductor laser, an organic light emitter, a micro-electromechanical systems (MEMS) heater, a light bulb, and the like. The light emitter 3 is provided in a defined region on the main surface 20 of the substrate 2. The defined region is determined to be a position facing a first mirror 511 (described later) in the z-axis direction. The light emitter 3 may include an optical filter having a wavelength selection function or a lens having a light condensing function.

The light receiver 4 (more specifically, the light-receiving element that constitutes the light receiver 4) is a component that receives light that has passed through a gas body introduced into a cell 54, which is described later. The light receiver 4 is not particularly limited as long as the light receiver 4 is sensitive to a band of light that includes a wavelength absorbed by the gas to be detected. According to the present embodiment, light received by the light receiver 4 is infrared light but is not limited to this example. According to the present embodiment, the light receiver 4 is a photodiode, but other examples include a phototransistor, a thermopile, a pyroelectric sensor, a bolometer, and the like. The light receiver 4 converts received light into an electrical signal and outputs the converted electrical signal. The electrical signal is output to, for example, an arithmetic unit. Upon receiving the electrical signal, the arithmetic unit calculates the concentration of the gas to be detected, based on light transmittance and the like. The light receiver 4 is provided in a defined region on the main surface 20 of the substrate 2. The defined region is determined to be a position facing a fifth mirror 513 (described later) in the z-axis direction. The light receiver 4 may include an optical filter having a wavelength selection function or a lens having a light condensing function. Further, when the gas sensor 1 is a photoacoustic gas detection device, the gas sensor 1 may include a microphone instead of the light receiver 4.

The light-guiding member 5 is a member that guides at least a portion of the light emitted by the light emitter 3 to the light receiver 4. The light-guiding member 5 is an optical system of the gas sensor 1. The light-guiding member 5 includes optical members and configures the optical path from the light emitter 3 to the light receiver 4. In other words, the light-guiding member 5 optically connects the light emitter 3 and the light receiver 4. Here, the optical members include, for example, mirrors, lenses, and the like. Further, the light-guiding member 5 is attached to the main surface 20 of the substrate 2 to form a cavity (cell 54) between the light-guiding member 5 and the main surface 20 of the substrate 2 into which gas is introduced. The ventilation opening 7 communicating with the cavity is provided to the top surface (first surface) of the light-guiding member 5.

According to the present embodiment, the light-guiding member 5 includes the first reflector 51 and the second reflector 52. The first reflector 51 includes the first mirror 511, a third mirror 512, and the fifth mirror 513 as optical members. The first reflector 51 includes a mirror that first reflects light emitted from the light emitter 3 and a mirror that finally reflects light received by the light receiver 4. The second reflector 52 includes a second mirror 521 and a fourth mirror 522 as optical members. The light-guiding member 5 reflects light emitted by the light emitter 3 in this order from the first mirror 511, the second mirror 521, the third mirror 512, the fourth mirror 522, and the fifth mirror 513, and guides light to the light receiver 4. The optical path is configured to traverse through the cell 54 between the light-guiding member 5 and the substrate 2, where a gas body is introduced. As another example, the number of mirrors provided to the light-guiding member 5 may be a number of one or more other than five. Further, the light-guiding member 5 may be configured to include a lens or a diffractive optical element in a portion of the optical path.

In the light-guiding member 5, a position of the first reflector 51 relative to the second reflector 52 is fixed. For example, the first reflector 51 and the second reflector 52 may be made of resin and formed integrally. More specifically, for example, the light-guiding member 5 may be formed by integrally injection molding all portions except for the mirrors using resin, and then each mirror may be formed by sputtering, vapor deposition, coating or plating a metal such as aluminum. Further, the light-guiding member 5 may be formed by machining metal and resin or by metal press working. As another example, the first reflector 51 and the second reflector 52 may be formed separately and then firmly fixed together by adhesive, screws, nails, fittings, grommets, welding, caulking, or the like. Further, each mirror may have a protective film to protect the reflecting surface.

The first mirror 511 is a light-focusing mirror that reflects light emitted from the light emitter 3 (more specifically, the light-emitting element that constitutes the light emitter 3) at a focal point. The first mirror 511 is, for example, a concave mirror. The first mirror 511 may have an ellipsoidal shape. According to the present embodiment, the first mirror 511 reflects light emitted in the z-axis direction from the light emitter 3 at the focal point in the xy plane direction. Here, the xy plane direction is a direction having a component in at least one of the x-axis direction and the y-axis direction. However, the xy plane direction may further include a z-axis direction component.

The second mirror 521, the third mirror 512, and the fourth mirror 522 reflect incident light. At least one of the second mirror 521, the third mirror 512, and the fourth mirror 522 may be a focusing mirror having a light-focusing function. At least one of the second mirror 521, the third mirror 512, and the fourth mirror 522 may be, for example, a concave mirror. As illustrated in FIG. 4, the second mirror 521 reflects light incident from the first mirror 511 to the third mirror 512. The third mirror 512 reflects light incident from the second mirror 521 to the fourth mirror 522. The fourth mirror 522 reflects light incident from the third mirror 512 to the fifth mirror 513.

The fifth mirror 513 is a focusing mirror that focuses incident light onto the light receiver 4. The fifth mirror 513 is, for example, a concave mirror. The fifth mirror 513 may have an ellipsoidal shape. According to the present embodiment, the fifth mirror 513 reflects incident light in the xy plane direction from the fourth mirror 522 so that the light has a component in the z-axis direction. Specifically, the fifth mirror 513 reflects incident light so that the light is focused on the light receiver 4 (more specifically, the light-receiving element that constitutes the light receiver 4) at the focal point.

Material constituting the first mirror 511, the second mirror 521, the third mirror 512, the fourth mirror 522, and the fifth mirror 513 may be, for example, metal, glass, ceramics, stainless steel, or the like, but is not limited to these examples. From the viewpoint of improving detection sensitivity, the material of these mirrors is preferably a material that has a low light absorption coefficient and high reflectance. Specifically, the light-guiding member 5 is preferably a resin housing coated with mirrors each made of an alloy containing aluminum, gold, or silver, a dielectric, or a laminate of these materials. As the resin, preferred examples include engineering plastics such as polypropylene (PP), polyamide (PA), polyphenylene ether (PPE), polycarbonate (PC), and polymethyl methacrylate (PMMA), and more preferred examples include super engineering plastics such as polyphenylene sulfide (PPS), polyether ether ketone (PEEK), and liquid crystal polymer (LCP). Further, the resin may be a mixture of the above-mentioned resins. Further, the resin may contain a filler to increase mechanical strength and reduce a coefficient of thermal expansion. Here, the filler may be, for example, glass fiber or an inorganic material. From the viewpoint of reliability and deterioration over time, the resin housing is preferably a resin housing coated with a gold or gold-containing alloy layer. Further, forming a dielectric laminate on the surface of the metal layer to increase reflectance and avoid deterioration over time is preferred. When the first mirror 511 and the fifth mirror 513 are formed by sputtering, vapor deposition, coating or plating onto a resin housing, higher productivity and lighter weight can be achieved compared to when formed from separate metal material. Further, a difference in thermal expansion coefficient from the substrate 2 is reduced, thermal deformation is suppressed, and sensitivity fluctuation is suppressed. Further, the light-guiding member 5 may be formed by cutting. From the viewpoint of productivity, the light-guiding member 5 is more preferably formed by injection molding.

### Light-Guiding Member

### First Embodiment

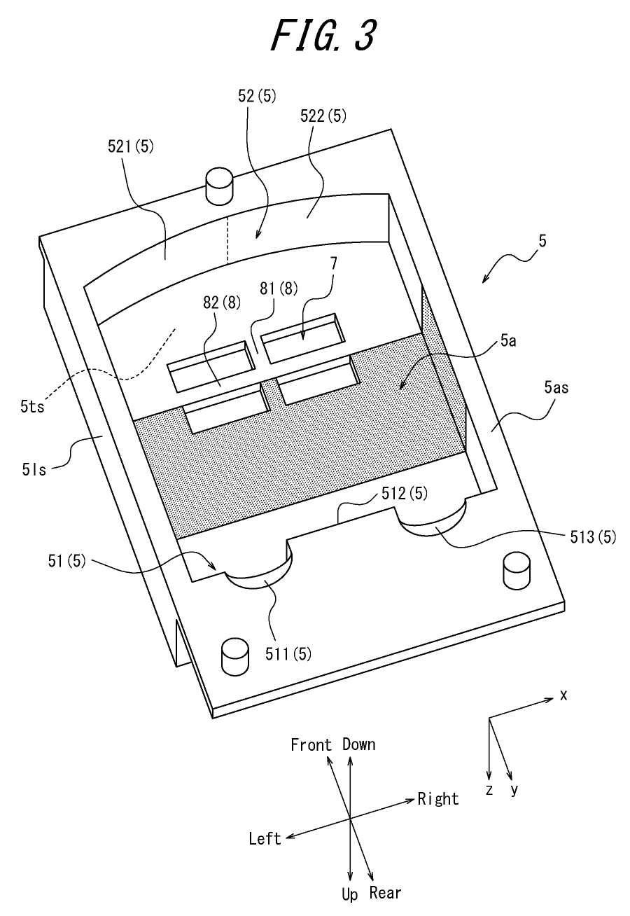

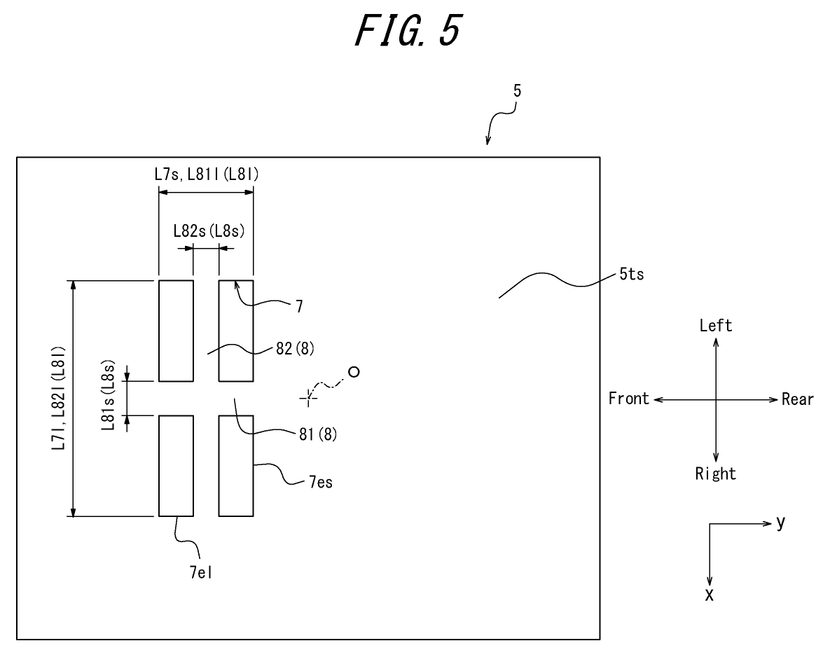

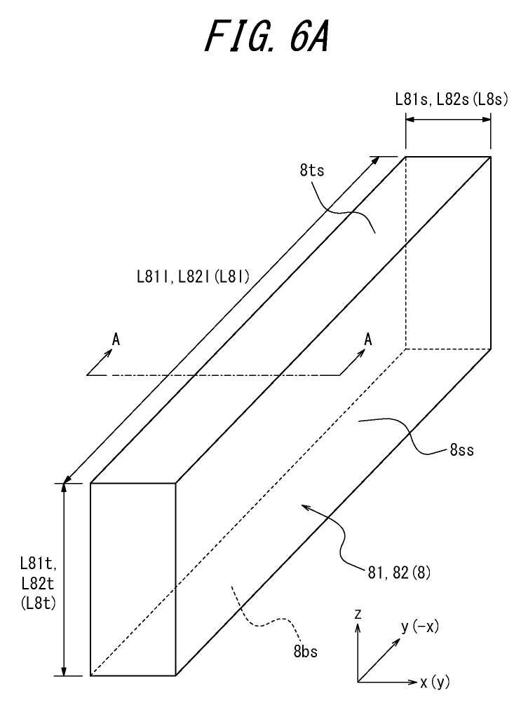

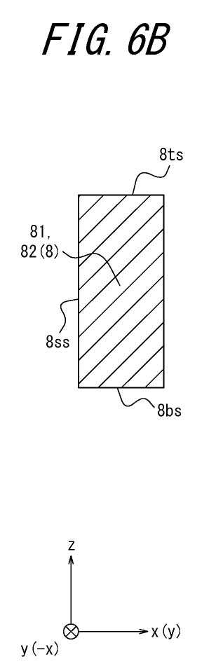

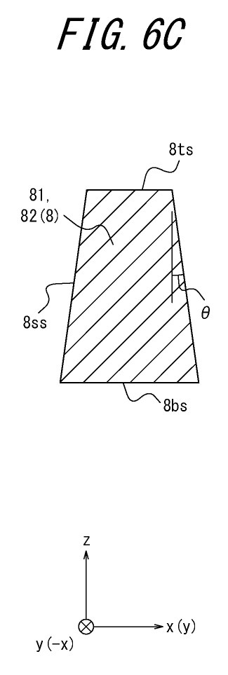

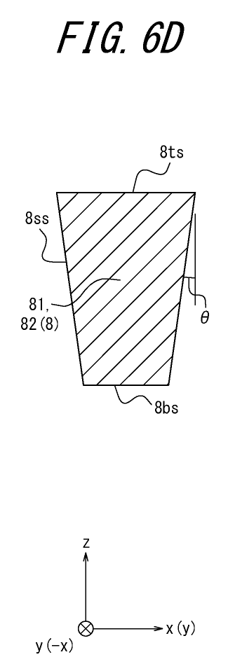

Next, the light-guiding member according to the first embodiment of the present disclosure is described in more detail, with reference to FIG. 2, FIG. 3, FIG. 5, and FIG. 6A to FIG. 6D.

FIG. 2 is a perspective view diagram of the light-guiding member according to the first embodiment of the present disclosure, which is included in the gas sensor of FIG. 1, viewed from above in a front right side view. FIG. 3 is a perspective view diagram of the light-guiding member of FIG. 2, viewed from below in a rear left side view. FIG. 5 is a plan view diagram of a top surface of the light-guiding member of FIG. 2 for explaining a configuration of the ventilation opening and beams. FIG. 6A is a perspective view diagram of one beam to explain a configuration of the beam, FIG. 6B is a cross-section diagram of a cross-section taken along A-A of FIG. 6A, and FIG. 6C is a cross- section diagram similar to FIG. 6B, illustrating another example of a cross-section taken along A-A of FIG. 6A. In FIG. 2, as in FIG. 1, the inside of the light-guiding member 5 visible through the ventilation opening 7 is not depicted. Hereinafter, "plan view" refers to viewing the light-guiding member and, in turn, the gas sensor from the outside in the positive z-axis direction (or the x-axis direction or the y-axis direction) from above along the z-axis direction (or the x-axis direction or the y-axis direction).

As illustrated in FIG. 2, FIG. 3, and FIG. 5, according to the present embodiment, the light-guiding member 5 has the ventilation opening 7. The ventilation opening 7 is an opening (through-hole) provided in the light-guiding member 5 for introducing a gas to be measured into a cell (cavity serving as an air chamber) 54 (see FIG. 1 and FIG. 4) formed between the light-guiding member 5 and the substrate 2, and for discharging the gas to be measured from the cell 54. The ventilation opening 7 is provided to a first surface of the outer surface of the light-guiding member 5. According to the present embodiment, the first surface is a top surface 5ts of the light-guiding member 5. According to the present embodiment, the configuration of the reflectors (the first reflector 51 and the second reflector 52) of the light-guiding member 5 is as described above. Hereinafter, the term "top surface" refers to the outer surface of the light-guiding member 5 opposite the substrate 2 in the z-axis direction. According to the present embodiment, as illustrated in FIG. 2, the light-guiding member 5 is formed in an approximately rectangular cuboid shape such that a length in the y-axis direction (front-rear direction) is longer than a length in the x-axis direction (left-right direction), excluding the front foot portion 55 that protrudes forward from the lower part of the light-guiding member 5 and the rear foot portion 56 that protrudes rearward from the lower part. According to the present embodiment, the top surface 5ts is the surface having the largest area among the outer surfaces of the light-guiding member 5 having an approximately rectangular cuboid shape. According to the present embodiment, the ventilation opening 7 is provided only to the first surface of the light-guiding member 5. However, instead of or in addition to the first surface, the ventilation opening 7 may be provided to a second to nth surface (n being a natural number of 5 or less) other than the first surface. In other words, the ventilation opening 7 may be provided to a left wall surface 5ls, a right wall surface 5rs, a front wall surface 5fs, and/or a rear wall surface 5bs of the light-guiding member 5 instead of or in addition to the top surface 5ts of the light-guiding member 5. According to the present embodiment, the top surface 5ts, the left wall surface 5ls, the right wall surface 5rs, the front wall surface 5fs, the rear wall surface 5bs, and a bottom surface 5as described below of the light-guiding member 5 are flat, but at least one may be curved. Further, the lower side of the top surface 5ts of the light-guiding member 5 is open downward so as to form the cell 54 between the light-guiding member 5 and the substrate 2. A particle filter (anti-dust filter) may be provided on the first surface (top surface 5ts according to the present embodiment) of the light-guiding member 5 so as to cover part or all of the ventilation opening 7. A material of the particle filter may be a polymer compound such as polytetrafluoroethylene (PTFE) or polyimide, a nonwoven fabric, an alumina (aluminum oxide) plate, or any other suitable material. Further, a recess may be provided around the ventilation opening 7 to facilitate attachment of the particle filter. The recess may be formed downward from the top surface 5ts of the light-guiding member 5 to a depth of 0.05mm to 0.2mm.

According to the present embodiment, the ventilation opening 7 is formed in a rectangular shape in plain view. Hereinafter, the term "rectangle" refers to a rectangle in the narrow sense, excluding squares. The term "rectangular" means that the shape is essentially rectangular, and vertices (corners) may be slightly rounded for production reasons, for example. Further, the term "rectangular" does not require that the short sides and/or long sides are completely parallel to each other, and the short sides and long sides do not have to be perpendicular to each other. Further, at least one side may be somewhat distorted. More specifically, according to the present embodiment, as illustrated in FIG. 5, the ventilation opening 7 is formed in a rectangular shape having a length in the x-axis direction (left-right direction) that is longer than a length in the y-axis direction (front-rear direction). However, the shape of the ventilation opening 7 in plain view is not particularly limited. The ventilation opening 7 may be formed in, for example, an elliptical shape, an oval shape, or the like. In the illustrated example, it is considered that there are four openings on the top surface 5ts of the light-guiding member 5, but hereinafter, for example, these four openings are collectively regarded as one of the ventilations opening 7 provided with beams 8 (a first beam 81 and a second beam 82 described below). Similarly, hereinafter, when the first surface of the light-guiding member 5 (the top surface 5ts according to the present embodiment) has a plurality of openings (through-holes) for introducing and discharging gas, then, in plain view, among a plurality of hypothetical regions each obtained by extrapolating two or more openings as a whole along their outer opening edges so as to enclose the two or more openings, a hypothetical region having the largest area and that does not have a land portion (referring to a non-opening portion) between the openings within the region of an area equal to or greater than the area of any opening, is considered to be one ventilation opening 7. The above-mentioned "hypothetical region obtained by extrapolating ... to enclose" is, in other words, in plain view, a hypothetical region obtained by considering two non-orthogonal line segments obtained by connecting any point on opening edges of each of any two openings and repeatedly carrying out an operation of cutting out a land portion existing between the two line segments, with the land portion removed and the openings connected.

As illustrated in FIG. 2, FIG. 3 and FIG. 5, according to the present embodiment, the ventilation opening 7 has at least one beam 8. In the illustrated example, the ventilation opening 7 has two beams 8, the first beam 81 and the second beam 82. The beams 8 (the first beam 81 and the second beam 82) extend between edges (opening edges) of the ventilation opening 7. More specifically, the beams 8 (the first beam 81 and the second beam 82) extend linearly between the edges (opening edges) of the ventilation opening 7. That is, the beams 8 (the first beam 81 and the second beam 82) extend linearly in plain view between the edges (opening edges) of the ventilation opening 7 so as to connect the edges. More specifically, as illustrated in FIG. 5, for example, the first beam 81 extends between the two short edges (in this example, the y-axis direction edges) 7es (the front short edge and the rear short edge; only one is marked in FIG. 5) of the rectangular ventilation opening 7 so as to connect the two short edges. In other words, the first beam 81 is a beam that extends in the short direction of the ventilation opening 7. Further, for example, the second beam 82 extends between the two longitudinal edges (in this example, the x-axis direction edges) 7el (the left longitudinal edge and the right longitudinal edge; only one is marked in FIG. 5) of the rectangular ventilation opening 7 so as to connect the longitudinal edges together. In other words, the second beam 82 is a beam that extends in the longitudinal direction of the ventilation opening 7. It should be noted that "extends in the short (longitudinal) direction" means extending with at least a component in the short (longitudinal) direction. According to the present embodiment, the beam 81 extends aligned with the short direction of the ventilation opening 7 (that is, at an angle of 0° relative to the short direction), but the beam 81 may extend at an inclination angle relative to the short direction of the ventilation opening 7, for example, at any angle of less than 45°. According to the present embodiment, the beam 82 extends aligned with the longitudinal direction of the ventilation opening 7 (that is, at an angle of 0° relative to the longitudinal direction), but the beam 82 may extend at an inclination angle relative to the longitudinal direction of the ventilation opening 7, for example, at any angle of less than 45°. According to the present embodiment, the beams 8 (the first beam 81 and the second beams 82) are integrally formed from the same resin as the portion of the light-guiding member 5 surrounding the ventilation opening 7.

Next, the configuration (shape, dimensions, and the like) of the beam 8 according to the present embodiment are described with reference to FIG. 5 and FIG. 6A to FIG. 6D. FIG. 6A illustrates a configuration of one beam 8, with the beam 8 virtually cut out from both extending ends of the ventilation opening 7. Hereinafter, regarding FIG. 5 and FIG. 6A to FIG. 6D, when referring to simply the beam 8, this applies to either the first beam 81 extending in the short direction of the ventilation opening 7 or the second beam 82 extending in the longitudinal direction of the ventilation opening 7.

As illustrated in FIG. 6A, the beam 8 has a length L8t (length L81t for the first beam 81; length L82t for the second beam 82) in the plane-normal direction perpendicular to the first surface that is longer than the minimum length L8s (minimum length L81s for the first beam 81; minimum length L82s for the second beam 82) in the in-plane direction of the first surface. Here, according to the present embodiment, the "in-plane direction of the first surface" (hereinafter also referred to simply as "in-plane direction") more specifically refers to a direction parallel to the xy plane. Further, according to the present embodiment, the "plane-normal direction perpendicular to the first surface" (hereinafter also referred to simply as the "plane-normal direction") more specifically refers to the z-axis direction. In other words, according to the present embodiment, the thickness of the beam 8 in the up-down direction is longer than the length (width) in the short direction in plain view. Therefore, according to the present embodiment, the strength of the light-guiding member 5 is less likely to decrease due to the provision of the beam 8 having high thickness to the ventilation opening 7, which in turn suppresses deformation of the light-guiding member 5 and therefore the reflectors, thereby helping prevent a decrease in function as a sensor. Further, the beam 8 is narrow, and therefore a sufficient opening area of the ventilation opening 7 can be secured. According to the present embodiment, the beams 8 (the first beam 81 and the second beam 82) are each formed to have a rectangular shape in plain view, but the shape of the beams 8 in plain view is not particularly limited. Further, the length (thickness) L8t of the beams 8 in the plane-normal direction may be the same as a thickness of a solid portion including the top surface 5ts of the light-guiding member 5.

Further, according to the present embodiment, the maximum in-plane direction length L8l of the beams 8 (maximum length L81l for the first beam 81; maximum length L82l for the second beam 82) is three or more times the minimum in-plane direction length L8s (minimum length L81s for the first beam 81; minimum length L82s for the second beam 82). Therefore, according to the present embodiment, the beam 8 has a narrow width, and therefore the opening area of the ventilation opening 7 can be more effectively secured. In order to secure the strength of the beam 8, the maximum length L8l of the beam 8 in the in-plane direction can be set to, for example, 5 times or less the minimum length L8s in the in-plane direction.

As described above, according to the present embodiment, the light-guiding member 5 has the ventilation opening 7 on the first surface, so that the gas to be measured can be introduced into the cell 54 formed between the light-guiding member 5 and the substrate 2, and the gas to be measured can be discharged from the cell 54.

Further, the ventilation opening 7 has at least one beam 8 extending between edges of the ventilation opening 7, and therefore it is possible to suppress a decrease in strength of the light-guiding member 5 due to the provision of the ventilation opening 7.

Further, the length L8t of at the least one beam 8 in the plane-normal direction perpendicular to the first surface is longer than the minimum length L8s in the in-plane direction of the first surface, and therefore the decrease in strength of the light-guiding member 5 can be more effectively suppressed and the opening area of the ventilation opening 7 can be sufficiently secured.

As described above, according to the present embodiment, it is possible to provide the light-guiding member 5 that has the ventilation opening 7 with a sufficient opening area, and that is less prone to lose strength. Further, by securing a sufficient opening area, an inflow of gas is promoted, shortening the response time of the gas sensor, thereby contributing to improved detection performance.

Further, the maximum in-plane direction length L8l of the at least one beam 8 is three times or more the minimum in-plane direction length L8s, and therefore the opening area of the ventilation opening 7 can be more sufficiently secured.

Preferred configurations and variations of the light-guiding member 5 of the present embodiment are further described below.

According to the present embodiment, as described above, the first surface of the light-guiding member 5 having the ventilation opening 7 is the top surface 5ts of the light-guiding member 5.

As described above, the top surface 5ts is the surface with the largest area among the outer surfaces of the approximately rectangular cuboid light-guiding member 5, and therefore it is easy to provide the ventilation opening 7. On the other hand, particularly in this case, when an external force is applied in a direction perpendicular to the surface (in the case of the top surface 5ts, the y-axis direction), the top surface 5ts is more likely to deform than other surfaces. Therefore, when the first surface having the ventilation opening 7 is the top surface 5ts, by providing the beam 8 to the ventilation opening 7 as in the present embodiment, the effect of the present disclosure of making the strength of the light-guiding member 5 less prone to decrease can be more effectively obtained, and ultimately, deformation of the light-guiding member 5 can be more effectively suppressed.

According to the present embodiment, as illustrated in FIG. 2, FIG. 3, and FIG. 5, in a hypothetical configuration in which no beam 8 is provided in the ventilation opening 7, that is, in a hypothetical configuration in which it is assumed that the portion of the beam 8 in the ventilation opening 7 is also open in the plan view of FIG. 5, the ventilation opening 7 is rectangular in plain view, and it is preferable that the at least one beam 8 includes the first beam 81 extending in the short direction of the ventilation opening 7 in the in-plane direction. The ventilation opening 7 in this hypothetical configuration corresponds to the hypothetical region having the largest area that is regarded as one ventilation opening 7, as described above.

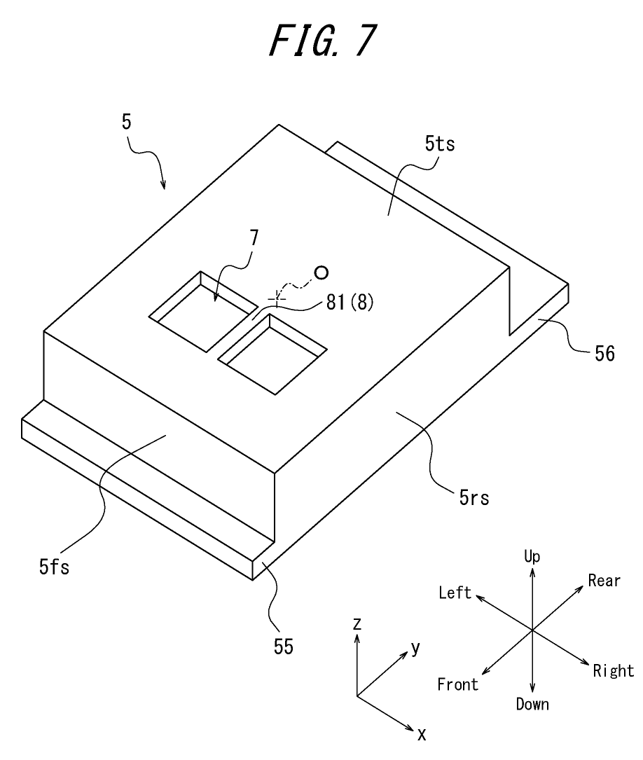

Here, the ventilation opening 7 is rectangular in plain view, that is, it has a length L7l in the longitudinal direction (x-axis direction in the example of FIG. 5), which is the longest direction of the ventilation opening 7 in the in-plane direction (direction parallel to the xy plane), and a length L7s in the short direction (y-axis direction in the example of FIG. 5), which is the direction perpendicular to the longest direction in the in-plane direction, and the longitudinal direction length L7l is greater than the short direction length L7s. As described above, the beam 8 includes the first beam 81 extending in the short direction of the ventilation opening 7 in the in-plane direction, in other words extending between the short edges 7es of the ventilation opening 7, and therefore a decrease in the strength of the first surface and therefore the strength of the light-guiding member 5 can be more effectively suppressed than, for example, when the beam 8 is the second beam 82 extending in the longitudinal direction of the ventilation opening 7 in the in-plane direction. According to the present embodiment, the ventilation opening 7 includes at least one beam 8, that is, the first beam 81 and the second beam 82, but the ventilation opening 7 may include only the first beam 81, as in another embodiment described below and illustrated in FIG. 7. Further, as illustrated, it is preferable that a hypothetical extension line of an extension direction of the first beam 81 in plain view passes through a center O of the top surface 5ts of the light-guiding member 5 or in a vicinity thereof (for example, within a circle having a diameter of 2mm centered on the center O). In other words, it is preferable that the extension direction is directed toward the center O of the top surface 5ts, from the viewpoint of uniformly improving the strength of the top surface 5ts when the ventilation opening 7 is provided. Further, as illustrated, it is preferable for balance that the first beam 81 is provided at the center in the longitudinal direction of the ventilation opening 7 or so as to include this center. When the ventilation opening 7 also has the second beam 82, it is similarly preferable for balance that the second beam be provided at the center in the short direction of the ventilation opening 7 or so as to include this center.

As illustrated in FIG. 6A to FIG. 6D, the first beam 81 has an upper surface 8ts parallel to the first surface (according to the present embodiment, the top surface 5ts) of the light-guiding member 5, and a side surface 8ss adjacent to the upper surface 8ts and extending in the plane-normal direction (according to the present embodiment, the z-axis direction). Here, "extending in the plane-normal direction" means extending with a component extending in the plane-normal direction. According to the present embodiment, as illustrated in FIG. 6A to FIG. 6B, the side surface 8ss of the first beam 81 extends at an angle of 0° with respect to the plane-normal direction in a cross-section view perpendicular to the extension direction of the first beam 81 in plain view. That is, the first beam 81 has a rectangular cross-section.

However, as illustrated in the variation of FIG. 6C, according to the present embodiment, the side surface 8ss of the first beam 81 may extend at an angle relative to the plane-normal direction (according to the present embodiment, the z-axis direction) so that the length of the first beam 81 in the in-plane direction (according to the present embodiment, the direction parallel to the xy plane) becomes shorter toward the upper surface 8ts in a cross-section view perpendicular to the extension direction of the first beam 81 in plain view. That is, the first beam 81 may have a trapezoidal cross-section having a long lower base. In such a case, the opening area of the ventilation opening 7 in the y-axis direction can be sufficiently secured, and the strength of the beam 81 and therefore the top surface ts of the light-guiding member 5 can be further improved. Further, when the light-guiding member 5 is formed by, for example, resin injection molding, the mold can be easily removed. Further, when the light-guiding member 5 is in an airflow that contains a large directional component parallel to the surface having the ventilation opening 7 on the outer surface of the light-guiding member 5, that is, the upper surface 8ts of the beam 81 according to the present embodiment, then, for at least one of the beams, that is, the beam 81 according to the present embodiment, a directional component that is perpendicular to the extension direction of the beam does not need to bend sharply sideways when flowing into the interior of the light-guiding member 5 through the ventilation opening 7. This is because there is an incline with respect to the plane-normal direction perpendicular to the surface to which the ventilation opening 7 is provided, that is, the upper surface 8ts of the beam 81 according to the present embodiment. As a result, gas flows in more smoothly, and gas inside the light-guiding member 5 is ventilated more smoothly.

In the above case, in a cross-section view perpendicular to the extension direction of the first beam 81 in plain view, it is preferable that an inclination angle q (see FIG. 6C) of the side surface 8ss of the first beam 81 with respect to the plane-normal direction (according to the present embodiment, the z-axis direction) is 0.5° to 10°. When the inclination angle q is 0.5° or more, the effects of improving the strength of the beam, facilitating removal of a mold, and improving ventilation performance can be sufficiently obtained, and when 10° or less, a decrease in the opening area of the ventilation opening 7 in the z-axis direction can be sufficiently suppressed. From the same viewpoint, the inclination angle q is more preferably 2° to 5°, and may be, for example, 3°.

Further, from a similar viewpoint, according to the present embodiment, as illustrated in FIG. 6D, the side surface 8ss of the first beam 81 may extend at an angle relative to the plane-normal direction (according to the present embodiment, the z-axis direction) so that the length of the first beam 81 in the in-plane direction (according to the present embodiment, the direction parallel to the xy plane) becomes longer toward the upper surface 8ts in a cross-section view perpendicular to the extension direction of the first beam 81 in plain view. That is, the first beam 81 may have a trapezoidal cross-section having a short bottom. Further, in such a case, a magnitude of the inclination angle q of the side surface 8ss of the first beam 81 with respect to the plane-normal direction (the z-axis direction according to the present embodiment) may be the same as the inclination described above. In such a case, the same effect as that of the inclination described above is obtainable.

From a similar viewpoint, the second beam 82 may also be configured such that the side surface 8ss does not have the above-mentioned inclination relative to the plane-normal direction, as in the case of the first beam 81 described above or may have any of the above-mentioned inclinations. It is also preferable that the second beam 82 has a configuration in which the side surface 8ss has the above-mentioned inclination with respect to the plane-normal direction. Further, in the examples illustrated in FIG. 6B to FIG. 6D, the cross-section shape of the beam 8 (the first beam 81 and the second beam 82) is symmetrical on the left and right sides of the drawing, that is, symmetrical with respect to a center line of the beam 8 in the short direction but may be configured asymmetrically. When the side surface 8ss of the beam 8 has the above-mentioned inclination with respect to the plane-normal direction, the in-plane direction lengths L8l and L8s of the beam 8 are measured in plain view of the upper surface 8ts of the beam 8.

As described above, according to the present embodiment, the ventilation opening 7 has a plurality of beams 8, and at least two of the beams 8 intersect with each other in plan view. More specifically, according to the present embodiment, the ventilation opening 7 has two beams 8 (the first beam 81 and the second beam 82) that intersect (more specifically, are perpendicular to) each other in plain view. In such a case, the strength of the top surface 5ts of the light-guiding member 5, and therefore the light-guiding member 5 itself, can be further improved compared to, for example, a case in which one beam 8 is formed for the ventilation opening 7 having the same opening area.

As illustrated in FIG. 3, the light-guiding member 5 may include a thin solid portion 5a between the first reflector 51 and the second reflector 52 in plain view. In FIG. 3, the thin solid portion 5a is indicated by a large number of dots. In this example, the thin solid portion 5a is a part of the light-guiding member 5 and is a portion that is thinner than remaining portions of the light-guiding member 5 other than the thin solid portion. More specifically, in this example, the thin solid portion 5a is a thin solid portion in which a rear side of the top wall, left side wall, and right side wall of the light-guiding member 5, which have the top surface 5ts, the left wall surface 5ls, and the right wall surface 5rs as their outer surfaces, is slightly thinner (for example, by some mm to some tens of mm). Here, "wall" in the above "top wall" and the like refers to a solid portion. In this way, by providing the thin solid portion 5a, it is possible to absorb strain occurring in the substrate 2 and the light-guiding member 5, and to more effectively suppress deformation of the light-guiding member 5. In addition, turbulence caused by a step on the rear side of the thin solid portion 5a can improve the ventilation performance of the ventilation opening 7 (the performance of introducing and discharging the gas to be measured into the cell 54).

### Second Embodiment

FIG. 7 is a perspective view diagram of the light-guiding member 5 according to a second embodiment of the present disclosure, viewed as in FIG. 2. The light-guiding member 5 of the second embodiment differs from the light-guiding member 5 of the first embodiment only in that the at least one beam 8 of the ventilation opening 7, and therefore the ventilation opening 7, does not include both the first beam 81 and the second beam 82, but only includes the first beam 81; other points are the same as those of the first embodiment described above, so detailed explanations are omitted.

According to the second embodiment, it is also possible to suppress a decrease in strength due to the presence of the ventilation opening 7 in the first surface of the light-guiding member 5, and therefore suppress a decrease in the strength of the light-guiding member 5, and to secure a more sufficient opening area of the ventilation opening.

### Gas Sensor

The gas sensor 1 according to an embodiment of the present disclosure includes the light-guiding member 5 according to any of the above-described embodiments and the substrate 2 described above. As described above, the gas sensor 1 is formed by attaching the light-guiding member 5 to the main surface 20 side of the substrate 2 as illustrated in FIG. 1 to FIG. 4. In this example, the light-guiding member 5 is fixed to the substrate 2 by adhesive or the like at a plurality of locations on the bottom surface 5as, but the means for joining the substrate 2 and the light-guiding member 5 is not particularly limited.

According to the gas sensor 1 of the present embodiment, the light-guiding member 5 has the configuration of any of the above-described embodiments, and therefore the light-guiding member 5 has the ventilation opening 7 that secures a sufficient opening area while being less prone to lose strength.

The above describes exemplary embodiments, and various modifications can be made without departing from the scope of the claims.

1. A light-guiding member for a gas sensor, attached to a main surface side of a substrate having a light emitter and a light receiver on the main surface side, the light emitter configured to emit light and the light receiver configured to receive at least a portion of the light emitted by the light emitter, the light-guiding member being configured to guide at least a portion of the light emitted by the light emitter to the light receiver, wherein
the light-guiding member comprises a first surface that is attached to a main surface in the light-guiding member to form a cavity into which a gas is introduced between the main surface of the substrate and the first surface, and that has a ventilation opening formed therein and communicating with the cavity, the ventilation opening includes at least one beam extending between edges of the ventilation opening, and the at least one beam has a length in a plane-normal direction perpendicular to the first surface that is longer than a minimum length of the at least one beam in an in-plane direction of the first surface.

2. The light-guiding member according to claim 1, wherein a maximum length of the at least one beam in the in-plane direction is three times or more the minimum length of the at least one beam in the in-plane direction.

3. The light-guiding member according to claim 1, wherein the first surface is a top surface of the light-guiding member.

4. The light-guiding member according to claim 1, wherein, in a hypothetical configuration in which the ventilation opening does not include the at least one beam,
the ventilation opening has a rectangular shape in plan view, and
the at least one beam includes a first beam extending in the short direction of the ventilation opening in the in-plane direction.

5. The light-guiding member according to claim 4, wherein the first beam has an upper surface parallel to the first surface and a side surface adjacent to the upper surface and extending in the plane-normal direction, and
the side surface of the first beam extends at an angle relative to the plane-normal direction so that, in a cross-section view perpendicular to an extension direction of the first beam in plan view, the length of the first beam in the in-plane direction becomes shorter or longer approaching the upper surface.

6. The light-guiding member according to claim 5, wherein, in a cross-section view perpendicular to the extension direction of the first beam in plan view, an inclination angle of the side surface of the first beam with respect to the plane-normal direction is 0.5° to 10°.

7. The light-guiding member according to claim 1, wherein the ventilation opening includes a plurality of beams that includes the at least one beam, and at least two of the beams intersect with each other in plan view.

8. The light-guiding member according to claim 1, wherein the first surface has a recess formed in a region including the ventilation opening and a periphery thereof in plan view.

9. A gas sensor comprising the light-guiding member according to claim 1 and the substrate.
